(19) United States
(12) Patent Application Publication
(10) Pub. No.: US 2008/0083590 A1
(43) Pub. Date: Apr. 10, 2008

(54) Base assembly for a motor brake mechanism

(76) Inventor: William Chuang, Shulin City (TW)

Correspondence Address: BIRCH STEWART KOLASCH & BIRCH, PO BOX 747, FALLS CHURCH, VA, 22040-0747, US

(21) Appl. No.: 11/542,188

(22) Filed: Oct. 4, 2006

(51) Int. Cl. F16D 65/24

(52) U.S. Cl. 188/170

(57) ABSTRACT

A motor brake mechanism includes a base which has a disk and hooks integrally extending from a peripheral edge of the disk to adapt to engage with a top face of the fixing plate. Because the hooks are integrally formed with the disk, the overall structural integrity of the base is enhanced. Thus position of the lining between the induced magnet and the friction disk is securely maintained.

### BACKGROUND OF THE INVENTION

1. Field of the Invention

The present invention relates to a base assembly, and more particularly to a base assembly for a motor brake mechanism to securely hold the lining in position so as to ensure that the lining is in full engagement with the friction disk inside the motor brake mechanism.

2. Description of the Prior Art

A motor often is used to carry a load via a conveying mechanism. When the power to drive the motor to operate is off, the operation of the motor is, of course, stopped. However, due to motion principles, the inertia of movement of the motor or the load as a result of the motor operation keeps the motor to rotate for a period of time. Or the potential energy of the load, which is transferred from the lifting by the motor, might cause the motor to operate in a reverse direction, which may damage the interior of the motor.

In order to prevent the motor from operation when the power is off, a motor brake mechanism is introduced to the market to help stop the movement of the motor. The currently available brake mechanism (5) is shown in FIGS. 4 and 5, and has a fixing plate (51), a friction disk (52), a lining (53), an induced magnet (54), clamping claws (55) and a base (56).

The fixing plate (51) has a centrally defined hole (511), multiple fixing legs (512) extending from a peripheral edge thereof and multiple fixing cutouts (513) each corresponding to one of the fixing legs (512).

The friction disk (52) has a driven tube (521) extending from a side face thereof and through the hole (511) of the fixing plate (51) and a through hole (522) defined through the driven tube (521) for receiving therein a motor shaft (not shown) such that the friction disk (52) is driven by the motor shaft to simultaneously rotate.

The lining (53) has multiple positioning cutouts (531) defined in a peripheral edge thereof to correspond to the fixing legs (512) of the fixing plate (51). The induced magnet (54) is cylindrical and connected to a power source which empower the motor for operation. The induced magnet becomes a magnet to attract the lining (53) to move toward the induced magnet so as to compress a resilient element (not shown) on a side face of the induced magnet (54). When the power is off, the lining (53) is pushed by the resilient element to move away from the induced magnet (54) to immediately adjacent to the friction disk (52).

Each clamping claw (55) has two hooks, a first hook and a second hook, respectively formed on a proximal end and a distal end thereof and linking together with one another. Each first hook is extended through a corresponding one of the positioning cutouts (531) and a corresponding one of the fixing cutouts (513) and hooked to a side face of the fixing plate (51). Each second hook is securely clamp a side face of the cylindrical induced magnet (54).

The base (56) has a disk and extensions (561) extending from a peripheral edge of the disk. Each extension (561) has a positioning recess (562) defined in an inner side face thereof to correspond to one of the clamping claws (55).

After the brake mechanism (5) is assembled as described earlier, an adhesive tape (57) is employed to secure the position of each of the clamping claws (55). Then the extensions (561) of the base (56) are applied to encompass the induced magnet (54).

As described earlier, the lining (53) is moved back and forth between the induced magnet (54) and the friction disk (52), which may somewhat deviate the position of each of the clamping claws (55). Because the position of the clamping claws (55) is not firmly secured, the movement of the lining (53) may not be perfectly aligned with the friction disk (52). That is, the lining (53) may be inclined relative to the friction disk (52). The oblique movement of the lining (53) relative to the friction disk (52) will not be able to provide sufficient friction to stop the motor operation such that often the motor suffers from internal damage, especially when the power to operate the motor is off.

To overcome the shortcomings, the present invention tends to provide an improved base assembly to mitigate the aforementioned problems.

### SUMMARY OF THE INVENTION

The primary objective of the present invention is to provide an improved base assembly to secure position of the lining inside the motor brake mechanism.

In order to accomplish the objective, the base assembly is composed of a base disk and claws extending from a periphery of the base disk such that after engagement between the base disk and a bottom face of the induced magnet, the claws engage with a top face of the fixing plate and received in the fixing cutouts. Because the claws are integrally formed with the periphery of the base disk, the structural integrity of the claws is enhanced.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the motor brake mechanism of the present invention;

FIG. 2 is a perspective view of the motor brake mechanism of the present invention;

FIG. 3 is a schematic side plan view showing the positioning of the lining by the claws;

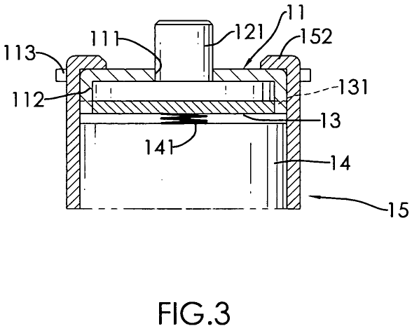

FIG. 4 is a partially exploded perspective view of a conventional brake mechanism; and

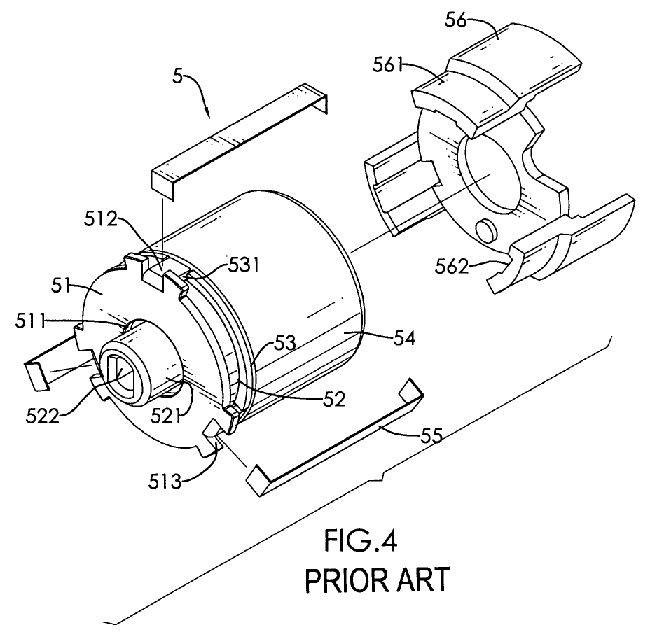

FIG. 5 is a partially exploded perspective view showing the application of the adhesive tape.

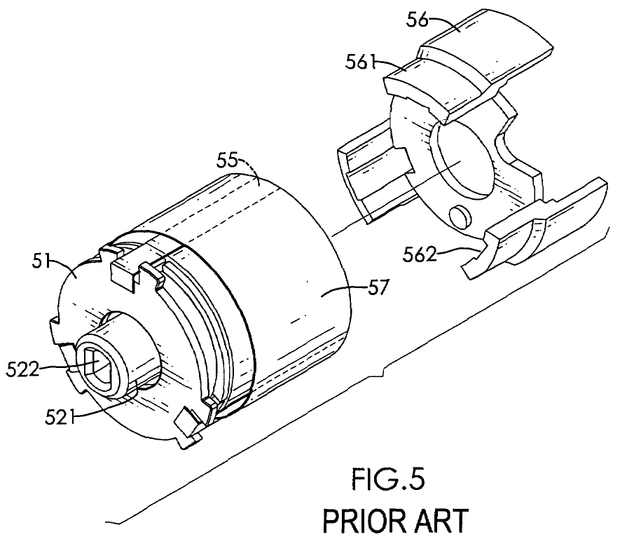

### DETAILED DESCRIPTION OF THE PREFERRED EMBODIMENT

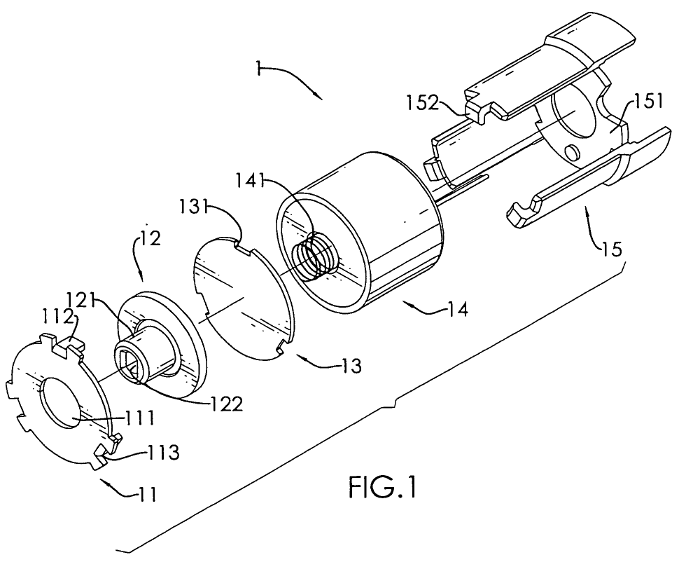

With reference to FIG. 1, it is noted that a motor brake mechanism (1) in accordance with the present invention includes a fixing plate (11), a friction disk (12), a lining (13), an induced magnet (14) and a base (15).

The fixing plate (11) has a centrally defined hole (111), multiple fixing legs (112) extending from a peripheral edge thereof and multiple fixing cutouts (113) each corresponding to one of the fixing legs (112).

The friction disk (12) has a driven tube (121) extending from a side face thereof and through the hole (111) of the fixing plate (11) and a through hole (122) defined through the driven tube (121) for receiving therein a motor shaft (not shown) such that the friction disk (12) is driven by the motor shaft to rotate simultaneously.

The lining (13) has multiple positioning cutouts (131) defined in a peripheral edge thereof to correspond to the fixing legs (112) of the fixing plate (11). The induced magnet (14) is cylindrical and connected to a power source which empowers the motor for operation. The induced magnet (14) becomes a magnet to attract the lining (13) to move toward the induced magnet (14) so as to compress a resilient element (141) on a side face of the induced magnet (14). When the power is off, the lining (13) is pushed by the resilient element (141) to move away from the induced magnet (14) to immediately adjacent to the friction disk (12).

The base (15) has a disk (151) and hooks (152) integrally extending from a peripheral edge of the disk (151).

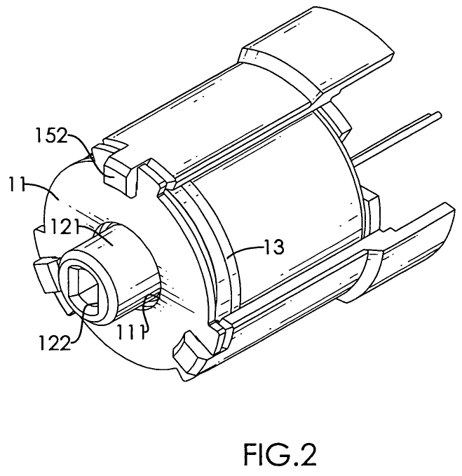

With reference to FIGS. 2 an 3, after the motor brake mechanism (5) of the present invention is assembled, it is noted that bodies of the hooks (152) extend through the positioning cutouts (131) and the fixing cutouts (113). Eventually, the hooks (152) engage a top face of the fixing plate (11).

Because the hooks (152) are integrally formed with the base (15), the structural integrity is enhanced such that when the hooks (152) are received in the fixing cutouts (113) and engage with the top face of fixing plate (11), the lining (13) is firmly secured between the induced magnet (14) and the friction disk (12). That is, the back and forth movement of the lining between the induced magnet (54) and the friction disk (12) as a result of the magnetic force and the recovery force from the resilient element (141) will not loosen the secured engagement between the hooks (152) and the fixing plate (11). Thus the lining (13) will always be kept in full engagement with the friction disk (12) when the power connecting to both the motor and the induced magnet (14) is off.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a motor brake mechanism having an induced magnet, a lining selectively moving toward to/away from the induced magnet, a friction disk selectively engaged with the lining and having a driven tube extending out of a hole defined in a fixing plate which is placed adjacent to the friction disk and a base encompassing the induced magnet, wherein the improvement comprises:
the base has a disk and hooks integrally extending from a peripheral edge of the disk to adapt to engage with a top face of the fixing plate so as to firmly maintain position of the lining between the induced magnet and the friction disk and keep the lining to be in full engagement with the friction disk.
